(19) United States
(12) Patent Application Publication
(10) Pub. No.: US 2007/0282675 A1
(43) Pub. Date: Dec. 6, 2007

(54) METHODS AND SYSTEMS FOR USER-PRODUCED ADVERTISING CONTENT

(76) Inventor: Kivin Varghese, Durham, NC (US)

Correspondence Address: PATENTBEST, 4600 ADELINE ST., #101, EMERYVILLE, CA, 94608, US

(21) Appl. No.: 11/421,011

(22) Filed: May 30, 2006

(51) Int. Cl. G06Q 30/00; G06Q 40/00

(52) U.S. Cl. 705/14; 705/35

(57) ABSTRACT

Systems and methods for facilitating the creation of user-produced advertising are disclosed. In the disclosed systems and methods, users are asked to produce advertising for specified products and to provide those advertisements to a central aggregator or facilitator. Based on the user-produced advertisements, the aggregator or facilitator may select one or more users for a reward. User-produced advertisements may be publicly posted for comment or distribution among users, and may be distributed in any communication medium. Users are also encouraged to form social networks around the user-produced advertising.

### BACKGROUND OF THE INVENTION

1. Field of the Invention

The invention relates to the field of advertising, and more generally, to methods and systems for managing the creation of user-produced advertising content.

2. Description of Related Art

The World Wide Web of the Internet has become an increasingly important resource for communication, information, business, social networking, and recreation. Recently, World Wide Web sites that host user-produced content have become particularly popular. In general, the term “user-produced content” refers to content, be it text, image, or multimedia, that is created by a user to be posted on a World Wide Web page or in some other public forum. Examples of user-generated content include web logs (i.e., blogs), and the individual user pages on World Wide Web sites such as LIVEJOURNAL, MySPACE and FRIENDSTER. Other examples include GOOGLE VIDEO and YOUTUBE, to which individual users can submit video clips for discussion and further distribution.

These popular sites rely on a “viral” approach to attract new users. As each user joins the site, he or she is encouraged to engage in the site by uploading his or her own content and, depending on the type of site, by personalizing a space on the site. Users are also asked to encourage their friends to join. That causes usage of particular World Wide Web sites and services to spread through established interpersonal social networks, with little or no advertising or marketing effort on the part of the World Wide Web site operator.

However, despite the popularity of sites that include user-produced content, site operators have yet to figure out how to effectively generate advertising revenue to support their sites, and advertisers have yet to figure out how to effectively reach users with advertising messages. Traditional web-based advertising includes so-called “banner” advertisements, which are advertisements placed on particular portions of World Wide Web pages. Typically, an advertiser is billed when a user “clicks” on the advertisement and is taken to the advertiser's own World Wide Web page for more information. Banner advertisements have become nearly ubiquitous, but their efficacy is unproven, and users often choose to ignore them altogether.

Some marketers have attempted to advertise through viral content distribution. However, recent attempts to do so have met with difficulties. For example, a video clip entitled “Lazy Sunday” produced by the television network NBC for the television program Saturday Night Live was widely seen and achieved some notoriety after it was posted to the YOUTUBE site and distributed widely via the Internet. Reports indicated that some viewers of the video clip were excited or amused by what they saw and generally wanted to watch Saturday Night Live after viewing the video clip. However, NBC Universal's response was to force the operators of the YOUTUBE site to stop offering the video clip for distribution.

In another well-publicized case, General Motors created a World Wide Web-based advertising campaign for the CHEVROLET TAHOE vehicle in which product-related videos were posted to the CHEVROLET website and users were permitted to create “advertising” by customizing those videos with various captions and messages. Users were also permitted to distribute the resulting finished video clips. As reported by the New York Times, many users used the opportunity to create parodies of the vehicle and its capabilities, some of them with very negative messages. The campaign was ultimately discontinued.

### SUMMARY OF THE INVENTION

One aspect of the invention relates to a method for advertising. The method comprises providing an advertisement production opportunity to a plurality of users through a communication network, specifying advertisement message elements, and allowing the plurality of users to produce user-produced advertisements. The methods also comprises identifying at least one user worthy of a reward based on the user-produced advertisements, providing the identified user with the reward, and providing personalized spaces for the plurality of users that allow each user to offer a listing of favorite users and one or more additional elements selected from the group consisting of biographical information, favorite advertisements, and external resources.

Another aspect of the invention relates to a method of creating advertising through a communication network. The method comprises collecting demographic, psychographic or behavioral information on a plurality of users and matching one or more of the plurality of users with an advertisement production opportunity. The method also comprises accepting user-produced advertisements responsive to the advertisement production opportunity through the communication network, identifying users among the plurality of users worthy of a reward based on the user-produced advertisements and providing the identified users with the reward. Users are also encouraged to form an interconnected social network around the user-produced advertising.

These and other aspects, features, and advantages of the invention will be set forth in the description that follows.

### BRIEF DESCRIPTION OF THE DRAWINGS

The invention will be described with respect to the following drawing figures, in which like numerals represent like elements throughout the figures, and in which:

FIG. 1 is general flow diagram of the tasks involved in a method according to one embodiment of the invention;

FIG. 2 is an illustration of an advertisement production opportunity presentation screen for use in the method of FIG. 1;

FIG. 3 is an illustration of an advertisement production opportunity information screen for use in the method of FIG. 1;

FIG. 4 is an illustration of an advertisement comment and rating screen for use in the method of FIG. 1;

FIG. 5 is an illustration of a personalized user page for use in the method of FIG. 1; and

FIG. 6 is a diagram of a system that may be used in carrying out the method of FIG. 1.

### DETAILED DESCRIPTION

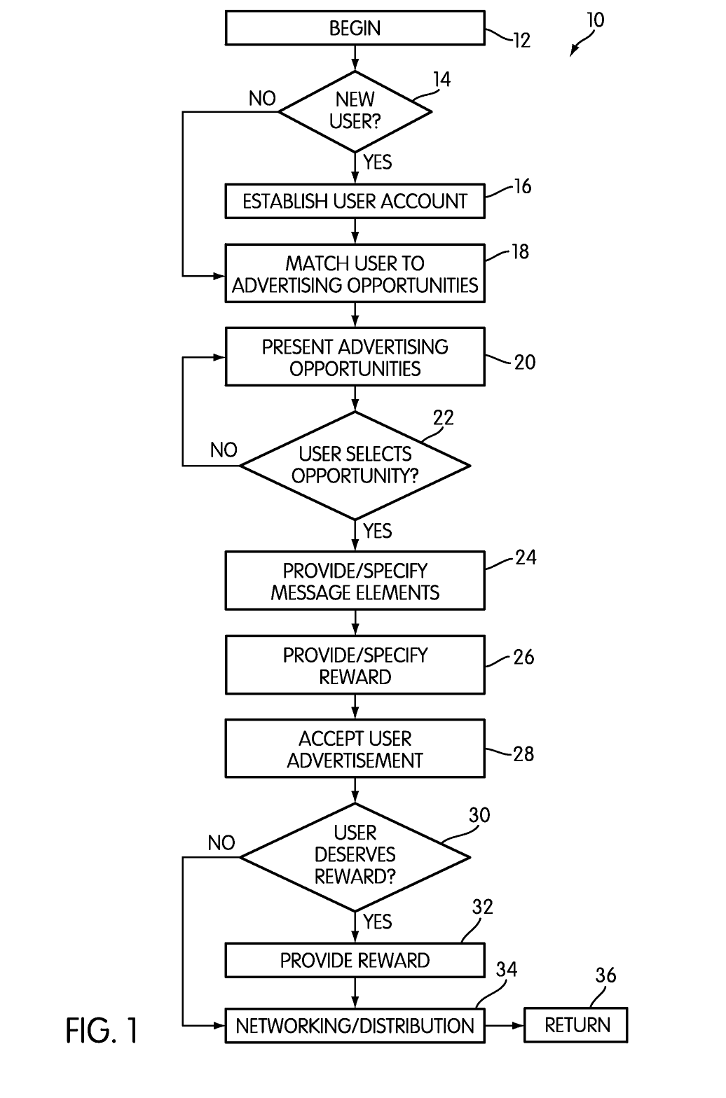

FIG. 1 is a general flow diagram of the tasks involved in a method, generally indicated at 10, according to one embodiment of the invention. In general, method 10 is a method for causing or facilitating the creation, evaluation, and distribution of user-produced advertising, particularly over a communication network, such as the World Wide Web of the Internet. Using method 10, the talents of a wide range of users and entities can be harnessed to create effective and appealing advertising.

The terms advertising and advertisement, which may be interchangeably used in this description, refer to any sort of material or presentation intended to inform the user of a particular product or service or to influence user behavior in some way. Examples of advertisements include product advertisements, service advertisements, political advertisements, and informational pages with data, imagery, or other information about the product or service. Advertisements may be presented in different formats. Examples of advertisement formats include videos, static display ads, spoken word and musical advertisements, and interactive games, questionnaires, and presentations.

The users of method 10 may be individuals or groups of individuals, depending on the embodiment. In some embodiments, as will be described below in more detail, the users of method 10 may be entities, such as businesses. For that reason, the term user, as used in this description, may refer to both individual users and to entities.

Method 10 may be performed in a variety of ways, with or without the use of automated electronic systems to manage its tasks. Specific embodiments of systems that may be used to carry out method 10 will be described below in more detail. Some of the description of method 10 presented below may assume that decisions regarding method 10 are made by a central unit, automated system belonging to the operator of method 10, and that a user interfaces with the central unit using a personal computing device connected to the central unit through a communication network, such as the Internet. Method 10 is particularly well suited for execution using the World Wide Web of the Internet.

The personal computing device used by the user may be any device capable of performing the functions attributed to it in this specification. Examples of personal computing devices include desktop and laptop personal computers, personal digital assistants (PDAs), cellular telephones, digital music and media players, televisions, and television set-top boxes.

Method 10 begins at task 12, with a user contacting the method operator's central unit, presumably through a communication network. Method 10 continues with task 14, a decision task, in which the central unit determines whether the user is a new user. The method operator typically keeps a database of known users, and a new user is thus one who is unknown to the method operator and its central unit. If the user is a new user (task 14: YES), method 10 continues with task 16, in which the user is asked to establish a new account. If the user is not a new user (task 14: NO), method 10 continues with task 18.

When establishing an account in task 16, a user may be asked for a variety of different types of information. Generally, the information collected in order to establish a new account may be any combination of basic contact information, demographic information, psychographic information, and behavioral information. Demographic information includes location and vital statistics. Psychographic information refers to information that tends to indicate the social class and lifestyle of a user. Behavioral information refers to information on specific behaviors, such as spending, shopping, visiting, and/or website browsing behaviors and activity. The user might be asked any number of questions that the operator of method 10 desires; however, the number of questions asked of the new user and the range of information collected at the outset would generally be balanced against the possibility of alienating the user and driving him or her away. Some questions that the user is asked when establishing a new account may be designated as “required” while other questions may be designated as “optional.”

In some embodiments, users may be screened at the outset based on their contact information. For example, users may only be permitted to register and establish a new account in task 16 if they live in a particular place, have an e-mail address from a particular domain, such as the “.edu” domain, have a cellphone number, or somehow are able to verify their identity or personal characteristics (e.g., gender and age) in some other way. Certain other conventional technologies may also be used to screen users at the outset. For example, a user could be asked to take a CAPTCHA™ (Completely Automated Public Turing Test to Tell Computers and Humans Apart) to confirm that the user is a real person. Users might also be asked to agree to terms of service or a privacy policy.

If the user is an entity, such as a business entity, the signup process may be slightly different in task 16. Business entities may be asked to provide their company name and address, and, perhaps, the name and telephone number of a primary contact.

The information gathered in task 16 may be put to a variety of uses, a number of which will be described below. The first use to which such information may be put is in the context of task 18, in which the user is matched with available advertising opportunities.

In method 10, the operator of method 10 has a number of advertisement production opportunities—instances in which a company, advertising agency, entity or individual is seeking to have an advertisement produced and has given the operator of method 10 authority to cause the advertisement to be produced by its users. The operator of method 10 may be a company with its own product line that is seeking to have advertisements produced. However, for purposes of the description that follows, it will be assumed that the operator of method 10 is a third party aggregator or facilitator who collects advertisement production opportunities from a number of sources, so that the advertisement production opportunities vary in industry, product, geographical location and reach, and in target demographics.

In some embodiments of method 10, matching a user to advertisement production opportunities may comprise nothing more than deciding to open all available advertisement production opportunities to that user. However, in some cases, it may not be the most efficient or productive course of action to present a user with an advertisement production opportunity for a product or service about which the user has no knowledge or in which the user has no interest. Therefore, in task 18, the user is generally matched with advertisement production opportunities in which he or she is likely to have the most interest or about which he or she is likely to have relevant knowledge.

For example, assume that one advertisement production opportunity is for a soft drink company. In that case, a user who is known to drink soft drinks, from responses to questions in task 16 or from other information, might be a good match for that advertisement production opportunity. Of course, this depends on the preferences expressed by the advertiser when setting out the advertisement production opportunity to the operator of method 10. In some cases, a particular soft drink manufacturer may want only loyal drinkers of its brands to produce advertisements. In other cases, the advertisement production opportunity may be deliberately opened to drinkers of other brands.

One particular situation in which matching may be useful is in the case of local advertisers. A method such as method 10 is most advantageously open to advertisement production opportunities from both local and national advertisers. A local advertiser, for example, a local or regional pizza chain, may ask the operator of method 10 for advertising produced in its locality or region by users who are familiar with its products and offerings. In that case, the advertisement production opportunity for the pizza chain might be matched only to users in the geographical region specified by the pizza chain, and perhaps also only to users who have expressed some familiarity with the chain's products. Of course, in other cases, a local or regional chain might want all users, regardless of location, to be presented with their advertisement production opportunity so as to garner the benefits of having a large, diverse group of users provide ideas and advertisements.

If one or more of the users participating in method 10 are business entities, method 10 may function as a business-to-business method for producing advertising. For example, assume that an advertiser controlling a very large and well-known brand provides the operator of method 10 with an advertisement production opportunity. The operator of method 10 could match that advertisement production opportunity with a number of small, competing advertising firms who might not otherwise have the opportunity to produce advertising for an advertiser controlling a very large and well-known brand.

Although shown in the context of a particular series of tasks, task 18, the task of matching a user to an advertisement production opportunity, may be performed at any time. For example, task 18 could be performed for each user when a new advertisement production opportunity is made available, or it could be performed at timed intervals, for example, every day or night at a particular time.

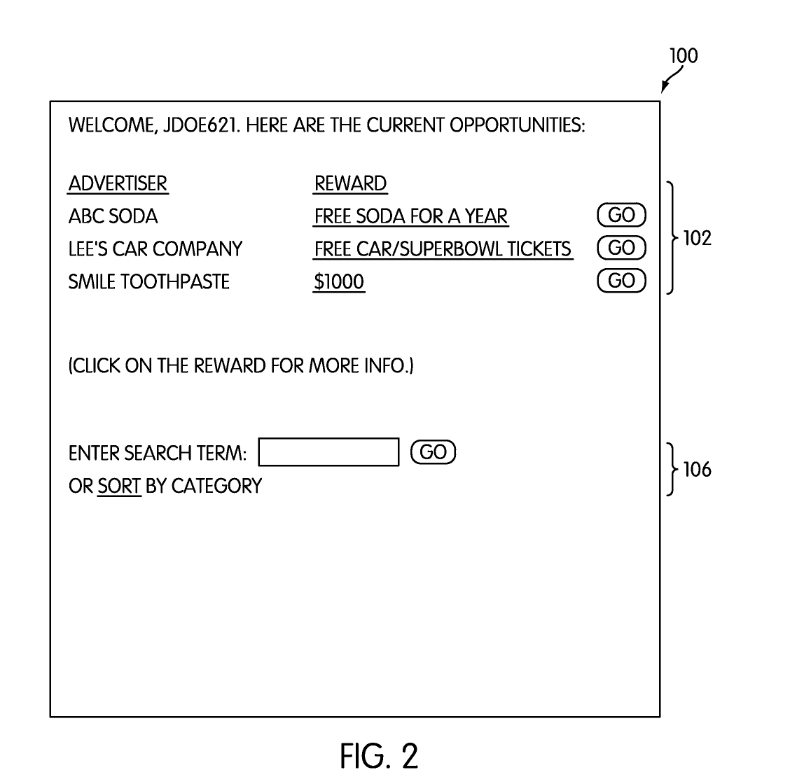

Once task 18 is complete and a user has been matched with one or more advertisement production opportunities, method 10 continues with task 20, in which the user is presented with available advertisement production opportunities with which he or she has been matched. FIG. 2 is an illustration of a screen 100 that may be used to present advertisement production opportunities to a user in one embodiment of the invention.

As shown in FIG. 2, screen 100 has an advertisement/reward section 102 that lists the various advertisement production opportunities. Advertisement/reward section 102 also provides a listing that includes a reward for the best user advertisement that is submitted in response to each advertisement production opportunity. Screen 100 also includes a sort and search portion 106 that allows a user to sort the available opportunities by category or type or to search for a particular category or keyword in the advertisement production opportunity listings. Typically, a screen like screen 100 would be presented through the World Wide Web or another communications network, and would appear on the user's personal computing device with the use of a web browser or another suitable client application.

Generally, users are more willing to provide creative ideas and to work if they derive benefit from the work. Therefore, in most embodiments of method 10, in exchange for producing user advertisements, any user who submits an advertisement that meets criteria established by the operator of method 10 is eligible to win a reward. Generally, the user who wins the reward is the one who submits the best user advertisement, as that term is defined by the operator of method 10. In essence, method 10 in part becomes a contest in which users compete for the specified rewards. The selection of the best user advertisement will be described in more detail below.

The reward offered for any particular advertisement production opportunity will vary with the nature of the product being advertised, the number and characteristics of users to whom the advertisement production opportunity is matched, the location of the users, and the budget and desires of the advertiser and the operator of method 10, among other factors. FIG. 2 gives three examples of rewards for best advertisement, all of them different, although the reward for some contests may be the same. As shown in FIG. 2, “ABC Soda” is offering free soda for a year, “Lee's Car Company” is offering a free car and SUPERBOWL championship football game tickets, and “Smile Toothpaste” is offering a $1,000 payment.

The reward listing of FIG. 2 also illustrates one way in which advertisement production opportunities may be matched to particular users or groups of users. In some cases, an advertiser may tailor an advertisement production opportunity to particular users by offering a reward that is only redeemable in a particular area of the country, or at stores owned by the advertiser. The local or regional pizza chain mentioned above, for example, may offer as a reward a free pizza or a number of free pizzas that are only available at its retail stores. Similarly, “ABC Soda,” one of the advertisers shown in screen 100 of FIG. 2, is offering free soda for a year, but the ABC soda company may make its products available in only some small geographic region of the country.

However, FIG. 2 also illustrates the possibility of creating large, tie-in promotions. The fictional “Lee's Car Company,” for example, is offering a free car to the winner, along with SUPERBOWL championship football game tickets. That advertiser (or the operator of method 10 in collaboration with the advertiser) might also make arrangements to have the winning user introduced and his or her advertisement played during the game, either in the stadium, on television, or both.

As shown in FIG. 1, method 10 continues with a decision task, task 22, once the user has been presented with advertisement production opportunities, and continues with task 24 once the user selects an advertisement production opportunity. As shown in FIG. 2, each advertisement production opportunity in advertisement/reward area 102 includes a “go” button that the user can click to obtain more information and/or submit an advertisement.

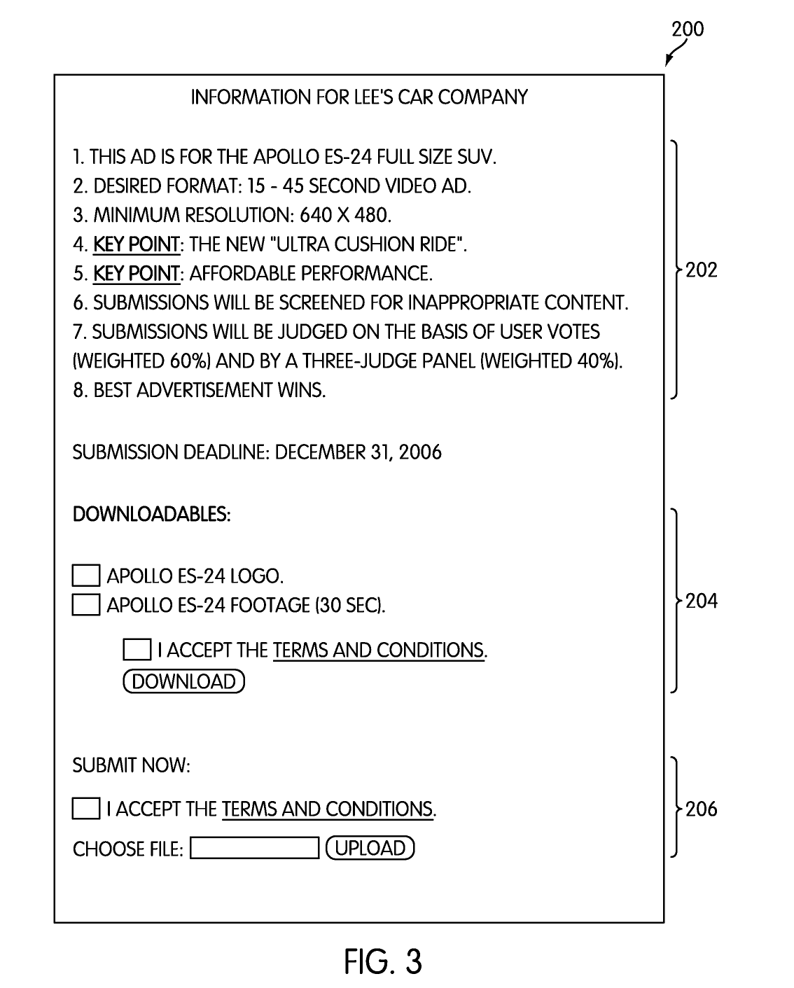

In tasks 24 and 26 of method 10, the user is provided with detailed information on the advertisement production opportunity. FIG. 3 illustrates screen 200, which may be used to provide this information. Screen 200 continues the example of the fictional “Lee's Car Company” illustrated in screen 100 of FIG. 2.

Typically, when presenting an advertisement production opportunity, the user is given such information as the desired format for the advertisement (audio, video, text, etc.), the desired length or size, and the desired resolution or file format. Information on how the submitted advertisements are to be judged may also be provided. Certain key message elements are also specified. Key message elements may include any points that the advertiser wishes the advertisements to address, or any themes to which the advertiser wishes the advertisements to hew. An advertiser may dictate virtually anything as a key message element.

For example, screen 200 includes an informational area 202 that sets forth the following basic information about the Lee's Car Company advertisement production opportunity:

### 1. This ad is for the Apollo ES-24 full size SUV.

2. Desired format: 15-45 second video ad.
3. Minimum resolution: 640×480.
4. Key point: the new “Ultra Cushion Ride”
5. Key point: affordable performance.

### 6. Submissions will be screened for inappropriate content.

### 7. Submissions will be judged on the basis of user votes (weighted 60%) and by a three-judge panel (weighted 40%).

### 8. Best advertisement wins.

### Of the information presented, the two “key points” or message elements are the product's “ultra cushion ride” and the product's “affordable performance” which the advertiser would like to be advertised.

Screen 200 also provides a download portion 204. This is an optional feature in methods according to embodiments of the invention. Download portion 204 exists to provide the user with advertisement elements that may be useful to the user in producing the advertisement. For example, the user could, as shown in FIG. 3, be provided with the product or manufacturer's logo, or with general video footage of the product in use, to name a few options. However, in other embodiments, the user may not be provided with anything, and may be left to use his or her own production capabilities and facilities to produce the advertisement. If the user is provided with advertisement elements, particularly those that contain material subject to copyright or trademark protection, the user may be required to agree with terms and conditions of use, as shown in FIG. 3.

As shown in FIG. 1, task 26 of method 10 involves providing the user with more information about the reward. In the illustrated screens 100 and 200, this was largely handled in screen 100. However, in some embodiments of the invention, users may be provided with the name of the advertiser or brand, but no information on the reward until later in the process. In that case, screen 200 may include a link to more information on the reward.

Task 28 involves accepting a user advertisement from a user. For the sake of illustration, an advertisement submission portion 206 is included in screen 200. Advertisement submission portion 206 allows the user to select a file from his or her own personal computing device and upload it to the method operator's central unit. Once uploaded, the file may be checked for compliance with technical and formatting requirements, and the user may be notified if there are technical problems with the file.

In alternate embodiments, or in cases where the amount of data is more than can be easily transmitted via the communication network, advertisements may be accepted by the operator of method 10 on conventional recordable media, such as CD-ROM and DVD-ROM as submitted by mail. However, on-line interactive submission of advertisements provides an immediacy and an error-checking capability not available with media submission by mail.

Once a user advertisement has been uploaded to the central unit, it is stored and processed by the operator of method 10 for judging. The judging process may be different for each advertisement production opportunity and for each advertiser. Depending on the particular circumstances, the best user advertisement may be chosen by the operator of method 10, by the advertiser, or by the users participating in method 10, or by any combination of the above. As the example of FIG. 3 illustrates, the fictional “Apollo ES-24” user advertisements are to be judged by both a three-judge panel (whose votes are weighted 40%) and by users (whose votes are weighted 60%). Other judging methods may be used. Some judging methods may be based on other metrics of popularity, such as total number of viewings or best click-through rates.

FIG. 3 illustrates an advertisement production opportunity in which the “best ad wins.” As was noted above, many different methods may be used to judge which ad is best. It is also not necessary that only one ad or only one user be rewarded. In some embodiments, many rewards may be given. For example, in some advertisement production opportunities, the user who creates the best or “first place” advertisement could receive $30,000, the user who creates the second best advertisement could receive $10,000, the user who creates the third best advertisement could receive $1,000, and ten runners-up could each receive free soda for a year. This kind of tiered reward approach could be used with rewards other than cash as well.

FIG. 1 illustrates that after submission of a user advertisement, the method continues with judging and determining which user or users deserve rewards in task 30, providing a reward to a user or users in task 32, and then networking and distribution activities in task 34, before the method ends at task 36. However, in embodiments of the invention, these tasks may happen in any order and may happen in parallel.

Submitted advertisements may initially be screened for questionable content, such as obscenity, by the operator of method 10. If an advertisement clearly contains obscenity or is known to be objectionable to the advertiser, it may be held by the operator of method 10 and precluded from any further distribution or viewing. In cases where the operator of method 10 is uncertain as to whether a user advertisement contains material that the advertiser considers inappropriate, the advertisement could be cordoned off and presented to the advertiser for approval or disapproval. The advertiser could, for example, be allowed to connect to the central unit through the network to view and approve or disapprove the advertisements using an appropriate graphical user interface. User advertisements on the questionable list would remain private until approved or disapproved by the advertiser, an agent of the advertiser, or someone else in authority.

Generally, if an advertisement does not include the key message elements identified in task 24, it would not be permitted to win the reward specified for the contest. In some embodiments, if an advertisement does not include the key message elements identified in task 24, it may not be further distributed.

As was described above, the best user advertisement may be determined, in whole or in part, by the votes of users active in method 10. During this phase of the method, the user advertisements may also be distributed in viral fashion amongst users of the method and others to generate publicity. Specifically, once an advertisement is determined not to contain objectionable content, it may be publicly posted for viewing, comment, and user rating. Various ways of posting media content for public comment are known in the art and any of these may be used in methods according to embodiments of the invention.

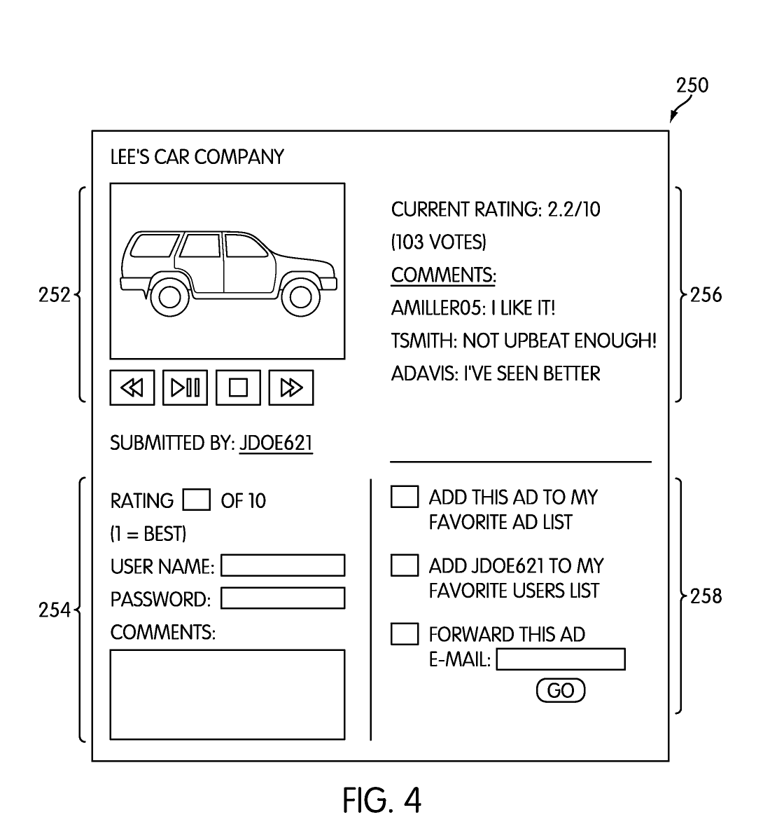

FIG. 4 illustrates one exemplary screen 250 that may be used to rate user advertisements, as well as to perform other functions. Screen 250 includes a display area 252 that allows an advertisement to be viewed. If the advertisement is a video advertisement, display area 252 may be provided by a plug-in application, such as WINDOWS MEDIA PLAYER or QUICKTIME that is used to view the advertisement. Rating area 254 allows the user to submit a rating (which is numerical on a scale of 1 to 10 in this case, although different rating systems may be used), as well as comments. In most embodiments, comments are associated with particular user names, so that user names, reputations, and personalities come to be known by other users. The current user rating and other user comments are shown in user reaction area 256, which displays comments that other users have made about the user advertisement as well as an aggregate or average rating from all users who have rated the particular advertisement.

The final portion of screen 250, user preferences section 258, allows a user to take certain further actions. In the illustrated embodiment of method 10, each user is provided with a space that can be personalized. As part of that personalization, each user is given the opportunity to identify favorite advertisements and favorite users. In user preferences section 258, users can add the advertisement on the page to their favorite ad list, they can add the user who created the advertisement to their favorite users list, and the can forward the advertisement to another person by e-mail address. If the advertisement is forwarded to another person who is not already a user, he or she may be offered the opportunity to join. Other embodiments of the invention may include other features.

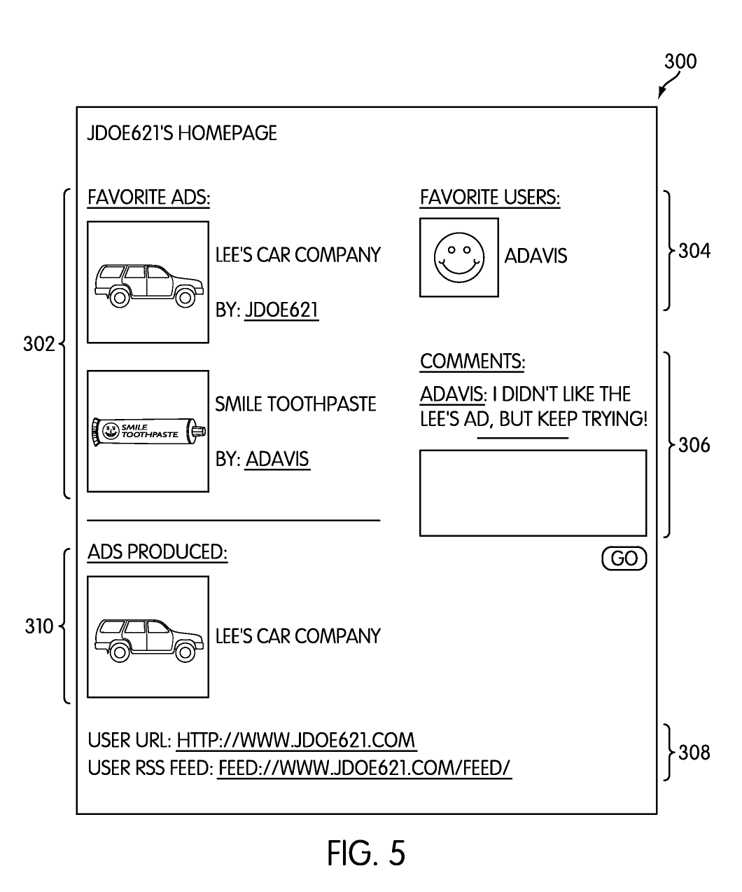

FIG. 5 illustrates a user personal screen 300. The user personal screen 300 includes indications of the user's favorite ads in a favorite ad area 302, the user's favorite other users in a favorite user area 304, comments from other users in a user comment area 306, links to a user's homepage or RSS feed in a user information area 308 and a listing of advertisements that the user has produced in an ad information area 310. Users may be permitted to customize personal screens like screen 300 using hypertext markup language (HTML), extensible markup language (XML) or CSS, to name a few, and might also add a personal statement or statement of interests, depending on the embodiment. Generally, the various areas 302, 304, 306, 308, 310 are implemented in hypertext so that if a viewer clicks on a particular area, he or she would then be given the opportunity to view the content. For example, if a user clicked on one of the advertisements shown in screen 300, he or she would then be provided with the opportunity to view that advertisement. Similarly, clicking on a user name or identifier would take the viewer to that user's personal screen 300.

Of the various areas in screen 300, user information area 308 allows the user to include external resources. For example, the user could specify his or her own web page and Really Simple Syndication (RSS) feed. Using these features, a user may link to other social networking providers by including a link to a weblog (i.e., a blog), to a personal website, or to a profile page on another social networking site. In some embodiments, content from other sources specified by the user may be directly displayed in the user information area 308. For example, if the user provides an RSS feed for his or her blog, the most recent entries may be displayed. The operator of method 10 may also provide discussion bulletin boards, in which case, a user information area 308 could include links to or feeds of discussions of interest to the user.

If the user is a business entity, the business entity may be provided with a space to advertise the entity's business, location, products, and capabilities, along with a listing of advertisements that they have produced. A screen such as this for a business entity might look much like screen 300. In some embodiments, business entities may be charged for the space.

Method 10 thus allows for advertisement production by a diverse group of users or entities. However, in doing so, it also creates a platform for social networking and advertisement distribution by viral means, i.e., from person to person, around the user-produced advertisements. If the operator of method 10 is an aggregator or facilitator, then method 10 may have the advantages of a wide variety of advertising production opportunities and a content moderator for the user advertisements that are produced.

Advertisements that are produced as a part of method 10 may be redistributed in any medium, including television, radio, print, and online media. If necessary, an advertisement may be retouched, polished, refined, or otherwise altered for distribution in a particular medium. This may be done, for example, if the user advertisement does not have a high enough resolution for television distribution.

Advertisements produced by means of method 10 or other methods according to embodiments of the invention may also be used in other advertising methods. For example, advertisements produced as a part of method 10 may be used in the pay-for-attention advertising methods, systems, and platforms described in U.S. patent application Ser. Nos. 10/474,242 and 11/382,616, which name the same inventor as this application and are incorporated by reference herein in their entireties.

The task of actually crediting a particular user with a reward may be performed in a variety of ways. If the reward is in the form of cash or merchandise credit, it may be transferred to the user in any negotiable form. Rewards may also be distributed in the form of coupons or certificates recognizable to the provider of the reward. U.S. patent application Ser. No. 11/382,616 contains a great deal of disclosure on the use of various techniques, infrastructure, and instruments to provide compensation to users, and those may be used to provide compensation in methods and systems according to the present invention.

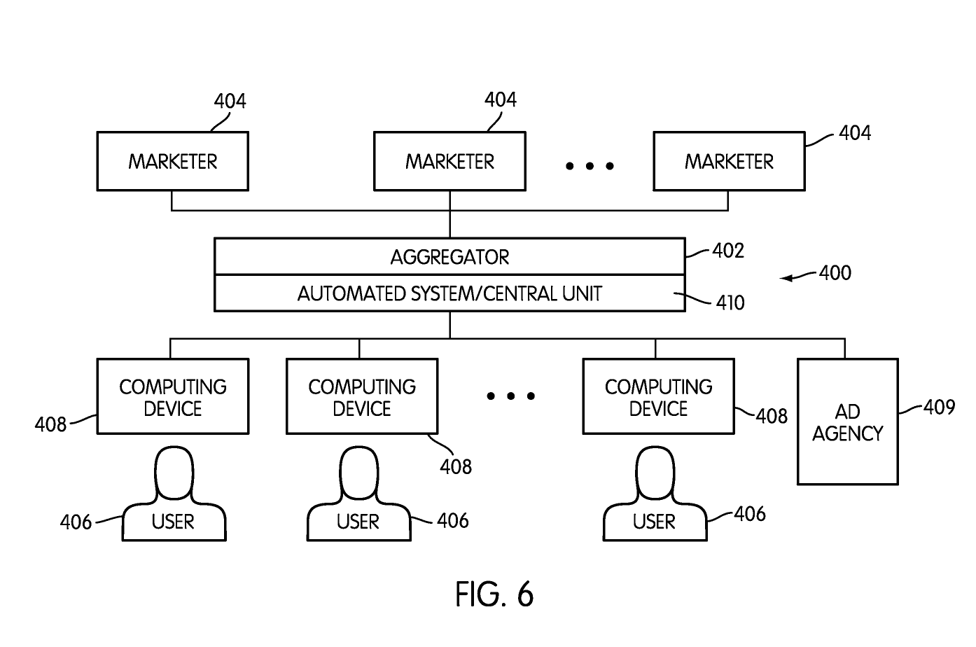

FIG. 6 illustrates a system, generally indicated at 400, that is suitable for performing method 10 and executing other methods according to embodiments of the invention. An aggregator 402 is at the center of system 400. The aggregator collects advertising production opportunities from a plurality of advertisers or marketers 404 in order to offer them to users 406 through their personal computing devices 408. As was described above, the users connected to the aggregator may include business entities such as ad agency 409.

In general, the aggregator 402 executes and manages the execution of methods like method 10, provides a central repository for the user advertisements in its central unit 410, and handles the other tasks described above with respect to method 10. The aggregator 402 also interfaces with the marketers 404 either through the communication network or by conventional means. In some embodiments, the aggregator 402 may handle and clear legal issues, such as copyright and trademark issues, for the users 406, 409.

Typically, the aggregator 402 would negotiate an arrangement with a marketer 404 allowing it to handle the preparation of one or more advertisements for the marketer 404. The marketer 404 would generally identify the type of advertisement it was seeking, the reward or rewards the marketer 404 is willing to offer, and any geographical or other preferences as to the users who are matched with the advertising production opportunity.

In one arrangement, the aggregator 402 could charge a flat fee for those services, and could pay out a portion of that fee as the reward or rewards for the best advertisements submitted by users. Of course, there is no requirement that the reward for a particular advertisement production opportunity come entirely from one marketer 404. In some embodiments, the aggregator 402 may pool resources acquired from several marketers 404 to provide a reward or rewards for an advertisement production opportunity. There is also no requirement that a reward or rewards be constrained to a single advertisement production opportunity. In some embodiments, rewards may be offered to users who submit, for example, the most user advertisements, or for those who submit a number of quality advertisements, even if none of those advertisements win the reward for their particular campaigns. Thus, the aggregator 402 has the ability to identify a user or multiple users worthy of rewards based on user-produced advertisements regardless of the outcome of any particular advertisement production opportunity and to determine what the reward should be.

As those of skill in the art will realize, the aggregator 402 will ultimately have a database of user information, including demographic, psychographic, and behavioral information. This information may be leveraged by the aggregator 402. U.S. patent application Ser. No. 11/382,616 contains additional information on building a database of user information and on leveraging that database, and the methods and techniques described there may be used in conjunction with the methods and systems described here.

Although the invention has been described with respect to certain embodiments, those embodiments are intended to be exemplary, rather than limiting. Modifications and changes may be made within the scope of the invention, which is determined by the claims.

1. A method for advertising, comprising:
providing an advertisement production opportunity to a plurality of users through a communication network;
specifying advertisement message elements;
allowing the plurality of users to produce user-produced advertisements;
identifying at least one user worthy of a reward based on the user-produced advertisements;
providing the identified user with the reward; and
providing personalized spaces for the plurality of users that allow each user to offer a listing of favorite users and one or more additional elements selected from the group consisting of biographical information, favorite advertisements, and external resources.

2. The method of claim 1, further comprising:
posting one or more of the user-produced advertisements; and
allowing one or more of the plurality of users to take one or more actions selected from the group consisting of viewing the user-produced advertisements, ranking the user-produced advertisements, commenting on the user-produced advertisements, and forwarding the user-produced advertisements or links to the user-produced advertisements to others.

3. The method of claim 1, further comprising distributing the user-produced advertisements through the communication network.

4. The method of claim 1, further comprising distributing the user-produced advertisements through other media channels.

5. The method of claim 1, further comprising publicly indexing the user-produced advertisements by user.

6. The method of claim 1, further comprising, for at least one of the plurality of users:
presenting one of the user-produced advertisements to the user;
confirming that the user has paid attention to the advertisement; and
if the user has paid attention to the advertisement, compensating the user.

7. The method of claim 1, wherein a plurality of entities is provided with an advertisement production opportunity and the entities are advertising agencies.

8. The method of claim 1, further comprising selecting particular users or entities from the plurality of users or entities to whom the advertisement production opportunity will be offered.

9. The method of claim 8, wherein the advertisement production opportunity is offered to particular users or entities who are in the same geographic region as an advertiser sponsoring the advertisement production opportunity.

10. Machine-readable instructions on a machine-readable medium interoperable with a machine to perform the method of claim 1.

11. A method of creating advertising through a communication network, comprising:
collecting demographic, psychographic, or behavioral information on a plurality of users;
matching one or more of the plurality of users with an advertisement production opportunity;
accepting user-produced advertisements responsive to the advertisement production opportunity through the communication network;
identifying users among the plurality of users worthy of a reward based on the user-produced advertisements;
providing the identified users with the reward; and
allowing the plurality of users to form an interconnected social network around the user-produced advertisements.

12. The method of claim 11, further comprising identifying a user worthy of a reward based upon the user-produced advertisements and providing the reward to the user.

13. An advertising method, comprising:
accepting candidate advertisements from users through a communication network;
selecting some of the candidate advertisements to distribute using the communication network;
distributing the selected candidate advertisements through the communication network;
identifying a best candidate advertisement at least in part by considering feedback on the selected candidate advertisements from the users; and
presenting an advertisement similar to or substantially the same as the best candidate advertisement.

14. The method of claim 13, wherein the communication network comprises the Internet.

15. The method of claim 13, wherein the advertisement is presented in association with an event.

16. The method of claim 15, wherein the advertisement is presented as a part of television coverage of the event.

17. The method of claim 15, wherein the event comprises a sporting event.

18. The method of claim 17, wherein the sporting event comprises the SUPERBOWL.

19. The method of claim 13, wherein the presented advertisement is a polished version of the best candidate advertisement.

20. The method of claim 13, wherein the selected candidate advertisements are distributed through the communication network so as to solicit feedback from users.
